(19) United States
(12) Patent Application Publication
(10) Pub. No.: US 2023/0115786 A1
(43) Pub. Date: Apr. 13, 2023

(54) METHOD AND SYSTEM FOR LONG RANGE Wi-Fi BACKSCATTER COMMUNICATION

(71) Applicants: ALI ABEDI, FREMONT, CA (US); OMID ABARI-SALEHI, LOS ANGELES, CA (US)

(72) Inventors: ALI ABEDI, FREMONT, CA (US); OMID ABARI-SALEHI, LOS ANGELES, CA (US)

(21) Appl. No.: 17/964,243

(22) Filed: Oct. 12, 2022

Related U.S. Application Data
(60) Provisional application No. 63/360,539, filed on Oct. 12, 2021.

(51) Int. Cl. H04B 1/06; H04W 84/12

(52) U.S. Cl. CPC H04B 1/06; H04W 84/12

(57) ABSTRACT

In this disclosure, a system and method for extending WiFi backscatter signal range is disclosed. By nulling a query signal at the receiver end, the receiver is able to more effectively receive a backscatter tag signal that has been generated in response to the query signal.

### CROSS REFERENCE TO OTHER APPLICATIONS

The disclosure claims priority from U.S. Provisional Application No. 63/360,539 filed Oct. 12, 2021 which is hereby incorporated by reference.

### FIELD

The present disclosure relates generally to WiFi communications. More particularly, the present disclosure relates to a method and system for long range WiFi backscatter communication.

### BACKGROUND

Backscatter communication is a technology that can be used for many Internet of Things (IoT) applications since it consumes near-zero power and enables IoT sensors to be battery free or run on a tiny battery for many years. One example of backscatter communication technology is Radio-Frequency IDentification (RFID) technology. Although RFID technology has been around for decades, the need for installing bulky and expensive RFID readers has hindered the use of this technology for many emerging applications such as, but not limited to, smart home services.

This has resulted in the use of WiFi backscatter communication technology for enabling communication between IoT sensors and existing WiFi transmitter and/or receiver devices (i.e. without using specialized readers). However, IoT sensors have been slow to utilize this technology. This is mainly due to the limited communication, or signal, range of WiFi backscatter technology, especially in non-line-of-sight (NLOS) scenarios.

The main reason for the limited signal range of WiFi backscatter technology systems compared to RFID technology communication systems is self-interference. In any backscatter system, there is a query signal that is transmitted by a WiFi transmitter device (which may be seen as a query device) to backscatter tags. In response to receiving the query signal, a backscatter tag sends its own data (such as in the form of a backscatter tag or backscatter tag signal) by modulating and reflecting the query signal back to a WiFi receiver, which may or may not be the same as the query device. The receiver then receives the backscatter tag's signal and separates it from the original transmitted query signal. However, as the distance between the receiver and the backscatter tag increases, the backscatter tag's signal becomes orders of magnitude weaker than the originally transmitted query signal and it becomes challenging for the receiver to separate and decode the weaker backscatter tag signal.

RFID readers solve this challenge by using special hardware, known as full-duplex radio. This hardware allows RFID readers to simultaneously transmit a query signal and decode the backscatter tag's signal even when the backscatter tag is located far from the RFID reader. In contrast to RFID readers, existing WiFi devices do not have full-duplex radios and therefore cannot simultaneously transmit and decode a backscatter tag's signal.

Current WiFi backscatter systems may be categorized into two categories which may be seen as in-channel and out-of-channel WiFi backscatter systems. In in-channel WiFi backscatter systems such as, but not limited to, WiFi backscatter and WiTAG systems, the query signal and the backscatter signal are in the same WiFi channel. These in-channel systems have very limited range since the backscatter signal is orders of magnitude weaker than the query signal resulting in the self-interference problem. In particular, in these systems, backscatter tags need to be relatively close to a WiFi receiver device in order for their backscatter signal to be decodable. For example, in WiTAG, the backscatter tag should be within about one meter from a WiFi receiver in a NLOS scenario. Similarly, for WiFi backscatter systems, the WiFi receiver should be less than about one meter from the backscatter tag.

To solve the range problem, out-of-channel WiFi backscatter systems (such as, but not limited to, SyncScatter systems) have been proposed. Out-of-channel systems shift a backscatter tag's signal to another channel, or communication channel, to avoid, or reduce, the self-interference problem. In the absence of a strong query signal, a backscatter tag may achieve a longer communication range compared to in-channel systems. However, this comes at a cost since the backscatter tag needs to shift its backscatter signal from the first or initial communication channel to another channel which may be seen as a second channel.

One problem of out-of-channel systems is that since the backscatter tags are incapable of performing WiFi carrier sensing, out-of-channel systems create interference for other WiFi traffic on the second channel and vice versa. Another problem is that out-of-channel systems require a 20 MHz clock to shift the signal which significantly increases their power consumption. Furthermore, a majority of out-of-channel systems require modification to existing WiFi transmitter and/or receiver devices in order for them to operate properly.

While WiFi devices may be modified and equipped with full-duplex hardware to enable them to transmit and receive simultaneously, this solution hinders the widespread deployment of WiFi backscatter systems due to the need to modify existing hardware. Also, when the backscatter tag's signal is shifted to another WiFi communication channel to avoid the self-interference, in these systems, the frequency of the backscatter tag's signal will be different than that of the query signal. This solution creates many limitations such as, but not limited to, requiring modification to existing

Therefore, there is provided a novel method and system for extending WiFi backscatter signal range.

### SUMMARY

The disclosure is directed at a method and system for extending WiFi backscatter signal range. In one embodiment, the disclosure uses nulling to null a query signal (transmitted by a WiFi transmitter) that is received by a WiFi receiver. Nulling of the query signals enables the WiFi receiver to more effectively clearly receive and decode a backscatter tag signal that is generated as a result of the query signal. Also, by nulling the query signal to remove self-interference, the WiFi receiver is able to receive and decode the backscatter signal when the tag is a distance away or where there is no line of sight (NLOS) between the receiver and the backscatter tag.

In one aspect of the disclosure, there is provided a method of extending signal range for a WiFi backscatter system including determining a channel for communication with a WiFi receiver; calculating at least one query signal based on the channel for communication; and transmitting one of the at least one query signals; wherein the at least one query signal is nulled when received by the WiFi receiver; wherein transmitting the at least one query signal is performed by a WiFi transmitter.

In another aspect, calculating the at least one query signal includes determining a number of transmitting chains; and calculating a query signal for each of the transmitting chains. In yet another aspect, the method includes storing each query signal for each of the transmitting chains. In a further aspect, calculating a query signal for each of the transmitting chains includes selecting one of the transmitting chains; determining a number of antennas associated with the selected transmitting chain; and determining an individual signal for transmission by each of the number of antennas; wherein the individual signals for transmission are nulled at the WiFi receiver; and wherein a combination of the individual signals for transmission by each of the number of antennas represent the at least one query signal. In yet a further aspect, the method includes determining if the WiFi receiver has decoded a backscatter tag signal; and transmitting another of the at least one query signals if the WiFi receiver has not decoded the backscatter tag signal; wherein the determining if the WiFi receiver has decoded the backscatter tag signal and transmitting another of the at least one query signals if the WiFi has not decoded the backscatter tag signal are repeated until the WiFi receiver has decoded the backscatter tag signal or each of the at least one query signals has been transmitted.

In another aspect, determining if the WiFi receiver has decoded a backscatter tag signal includes communicating with the WiFi receiver to determine if the WiFi receiver has decoded the backscatter tag signal. In yet another aspect, determining if the WiFi receiver has decoded a backscatter tag signal includes communicating with an external node monitoring WiFi receiver activity. In a further aspect, determining a channel for communication with a WiFi receiver includes channel sounding. In an aspect, determining a channel for communication with a WiFi receiver includes determining a relationship between antennas associated with the WiFi transmitter and at least one antenna associated with the WiFi receiver.

In another aspect of the disclosure, there is provided a non-transitory computer-readable medium storing a WiFi backscatter communication program including instructions that, when executed by a processor, causes a WiFi transmitter to determine a channel for communication with a WiFi receiver; calculate at least one query signal based on the channel for communication; and transmit one of the at least one query signals; wherein the at least one query signal is nulled when received by the WiFi receiver; wherein transmitting the at least one query signal is performed by a WiFi transmitter.

In another aspect, the instructions, when executed by the processor, cause the WiFi transmitter to calculate the at least one query signal, the WiFi transmitter determines a number of transmitting chains; and calculates a query signal for each of the transmitting chains. In a further aspect, the instructions, when executed by the processor, cause the WiFi transmitter to calculate a query signal for each of the transmitting chains, the WiFi transmitter selects one of the transmitting chains; determines a number of antennas associated with the selected transmitting chain; and determines an individual signal for transmission by each of the number of antennas; wherein the individual signals for transmission are nulled at the WiFi receiver; and wherein a combination of the individual signals for transmission by each of the number of antennas represent the at least one query signal. In yet another aspect, the instructions, when executed by the processor, further cause the WiFi transmitter to determine if the WiFi receiver has decoded a backscatter tag signal; and transmit another of the at least one query signals if the WiFi receiver has not decoded the backscatter tag signal; wherein the determining if the WiFi receiver has decoded the backscatter tag signal and transmitting another of the at least one query signals if the WiFi has not decoded the backscatter tag signal are repeated until the WiFi receiver has decoded the backscatter tag signal or each of the at least one query signals has been transmitted. In another aspect, the instructions, when executed by the processor, cause the WiFi transmitter to determine if the WiFi receiver has decoded a backscatter tag signal, the WiFi transmitter communicates with the WiFi receiver to determine if the WiFi receiver has decoded the backscatter tag signal. In yet another aspect, the instructions, when executed by the processor, cause the WiFi transmitter to determine if the WiFi receiver has decoded a backscatter tag signal, the WiFi transmitter communicates with an external node monitoring WiFi receiver activity.

In a further aspect of the disclosure, there is provided a WiFi transmitter including a processor for executing non-transitory computer-readable medium storing a WiFi backscatter communication program including instructions that, when executed by the processor, cause the WiFi transmitter to determine a channel for communication with a WiFi receiver; calculate at least one query signal based on the channel for communication; and transmit one of the at least one query signals; wherein the at least one query signal is nulled when received by the WiFi receiver.

In another aspect, the transmitter further includes a database for storing each of the at least one query signals. In a further aspect, the WiFi transmitter further includes a set of antennas for transmitting the one of the at least one query signals.

### BRIEF DESCRIPTION OF THE DRAWINGS

Embodiments will now be described, by way of example only, with reference to the attached drawings, in which:

FIG. 1 is a schematic diagram of a WiFi backscatter system environment;

FIG. 2 is a flowchart showing a method of improved WiFi backscatter communication;

FIG. 3 is a schematic diagram of signal strength in accordance with an embodiment of the disclosure;

FIG. 4a is a schematic diagram of signal strength when a query signal is nulled at the backscatter tag;

FIG. 4b is a schematic diagram of signal strength when a query signal is not nulled at the backscatter tag;

FIGS. 5a to 5c show directions in which query signals may be transmitted in order to achieve nulling;

FIG. 6 is a schematic diagram of a line-of-sign experimental set-up;

FIG. 7 is a chart showing experimental results of FIG. 6;

FIG. 8 is a schematic diagram of a no-line-of-sight experimental set-up;

FIG. 9 is a chart showing experimental results of FIG. 8;

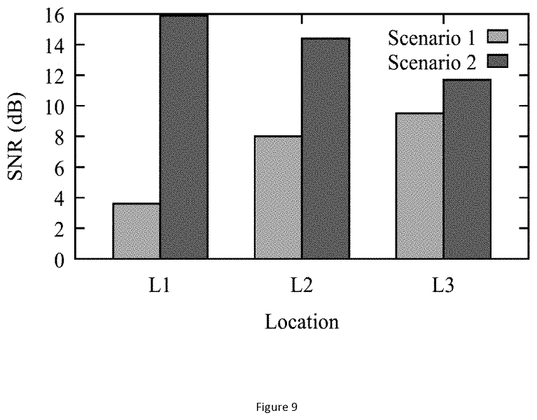

FIG. 10 is a table showing a comparison between the disclosure and other current communication systems; and

FIG. 11 is a schematic diagram of one WiFi backscatter system configuration.

### DETAILED DESCRIPTION

The disclosure is directed at a method and system for extending or improving WiFi backscatter signal range. In one embodiment, the disclosure reduces or eliminates self-interference by nulling a query signal that is received by a WiFi receiver. In one embodiment, the disclosure may be integrated with current WiFi devices without a need for hardware modification to these existing WiFi devices. In another embodiment, the disclosure improves a backscatter signal communication range without the need to use a second communication channel. In another embodiment, the disclosure improves the capability of backscatter communication in no or non-line-of-sight (NLOS) situations (i.e. where there is no line of sight between different components of the WiFi backscatter system).

Nulling is used to eliminate or reduce the effect of a transmitted signal (or query signal) at a particular station, such as a receiving or receiver station. Nulling is achieved by transmitting a query signal having multiple signal components (where the signal components have different phases and/or amplitudes) which cancel themselves out when they reach the receiver. The signal components are transmitted via multiple antennas within a WiFi transmitter device by adjusting a phase of the query signal component transmitted from each antenna. The phases are adjusted in a way that the transmitted signal components are added destructively at the particular receiving station, or receiver. The transmitted signal may be seen as a single query signal having multiple components that null themselves at the receiver or as a set of query signals where individual query signals null themselves at the receiver.

In one embodiment, the receiving device does not hear the transmitter signal due to the nulling thereby eliminating or reducing the self-interference. On the other hand, the backscatter tag receives, modulates and reflects the transmitter's signal to generate a backscatter tag signal. The receiving WiFi device can easily decode the backscatter tag's signal even when the tag is far away since there is no interference. Nulling is widely supported by current WiFi devices including almost all modern WiFi access points such that the disclosure may be easily implemented on current WiFi devices.

As discussed below, experiments were performed to determine the effectiveness of the disclosure using existing WiFi devices. The experiments showed that the method and system of the disclosure improved the signal range compared with existing WiFi backscatter systems.

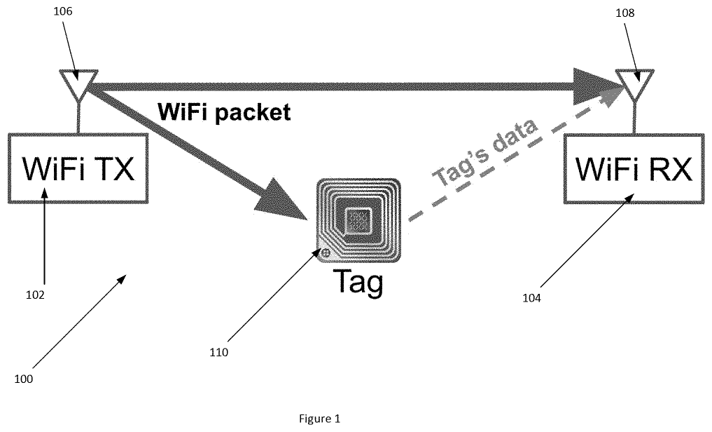

Turning to FIG. 1, a schematic diagram of a general environment for a WiFi backscatter system is shown. The WiFi backscatter system environment 100 includes a WiFi transmitter 102 that transmits a query signal that is received by a WIFi receiver 104. The query signal includes multiple signal components as will be described below. The WiFi transmitter 102 includes a set of antennas 106 that transmit the different signal components and the WiFi receiver 104 includes at least one antenna 108 for receiving the query signal (along with any other signals). As will be described below, the set of antennas 106 within the WiFi transmitter 102 includes at least two antennas such that nulling of the query signal at the WiFi receiver 104 can be achieved. In one embodiment, each of the antennas 106 sends a separate signal component whereby the combination of these signal components results in the query signal. In other embodiments, the query signal may be seen as a set of query signals where each of the signal components may be seen as a query signal that belongs to the set of query signals. The transmitter 102 may further include a database for storing the query signals.

For simplicity and ease of explanation, only one transmitter and one receiver are shown in this embodiment. While only one transmitter and one receiver are shown, it is understood that the system 100 may include any number of transmitters and receivers communicating with each other. The environment 100 may include at least one backscatter tag 110 that receives and reflects the set of query signals transmitted by the WiFi transmitter 100. This reflected signal (which may be seen as the backscatter tag signal) is then received and processed by the receiver 104.

In operation, the WiFi transmitter 102 sends or transmits WiFi packets (from each of the antennas 106) that represent the individual signal components. If present, a backscatter tag 106 individually receives the signal components and modulates the data from each of the signal components by backscattering the individual query signal component such as in the form of a reflected tag signal or backscatter signal. In some embodiments, the backscatter tag may receive all of the signal components and combine them before generating the backscatter tag signal. The WiFi receiver 104 receives the combination of the query signal and the backscatter signal and extracts the tag's data from the combined signals. By pre-determining the query signal, the effect of the individual query signal components are nulled when received by the WiFi receiver such that the receiver 104 extracts the one or multiple backscatter signals generated based on each of the query signal components.

With current backscatter systems, since the query signal is orders of magnitude stronger than a backscatter tag's reflected signal or the backscatter signal, the single query signal acts as an interference for the backscatter tag's signal (when received by the WiFi receiver). This results in a very low Signal to Noise and Interference ratio (SNIR). As the distance of the backscatter tag from the WiFi receiver increases, the SNIR will become too low for the WiFi receiver to successfully decode the tag's data (from the backscatter signal). This self-interference problem is a main reason why current WiFi backscatter systems have very limited signal range.

To address this problem, the disclosure provides a system and method of improving signal range for WiFi backscatter systems by using nulling. In one embodiment, by nulling the signal components of the query signal (at the receiver) transmitted by the transmitter, the WiFi receiver is better able to decode the reflected signal generated by the backscatter tag at distances farther than current systems are able which is currently limited to about one (1) meter between the backscatter tag and the WiFi receiver. As discussed below, nulling of the components of the query signal also allows the WiFi receiver to decode the reflected signal generated by the backscatter tag even when there is NLOS between the WiFi receiver and the backscatter tag.

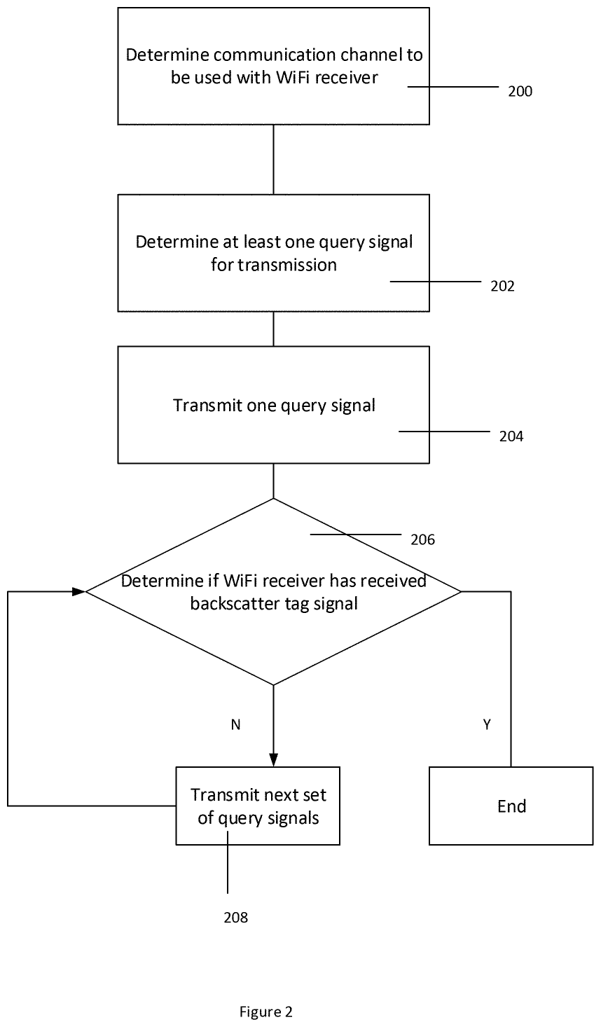

Turning to FIG. 2, a flowchart outlining a method of extending or improving WiFi backscatter signal range is shown. As discussed above, in one basic embodiment of WiFi backscatter communication, a WiFi transmitter transmits a query signal and, if present, a backscatter tag generates a backscatter tag signal for in response to the query signal. Each of the combined query signal and backscatter tag signal is then received and decoded by a WiFi receiver where the query signal is nulled such that the WiFi receiver only has to decode the backscatter tag signal. In one embodiment of the method of FIG. 2, the method is executed by the WiFi transmitter via the execution of code or instructions stored on a computer-readable medium within the transmitter or a processor within the transmitter.

As WiFi devices use Multiple-Input Multiple-Output (MIMO) technology that allows them to transmit and receive multiple concurrent WiFi signals (which may be seen as the individual query signal components and/or combination of the query signal and backscatter signal). If the WiFi transmitter has N transmitting chains, it can adjust the phase and amplitude of each chain independently.

Initially, the WiFi transmitter determines, or estimates, the channel over which the WiFi transmitter and the WiFi receiver are going to communicate (200). In one embodiment, this may be performed using channel sounding such as defined by the IEEE 802.11. By determining the communication channel, the transmitter is able to determine the properties or characteristics of the signal components of the query signal that is to be transmitted. After determining the communication channel, the system determines at least one query signal that will be nulled when received by the WiFi receiver (202).

In one embodiment, the system determines the number of antennas associated with the WiFi transmitter. Individual query signal components for each of the set of antennas are then determined whereby the query signal components (collectively seen as the query signal) are nulled by each other when received by the WiFi receiver. In another embodiment, query signal components may be determined only for at least two of the set of antennas as there may only need to be two individual query signal components to enable nulling of the query signal at the WiFi receiver. Having more than two signal components transmitted may also reduce a likelihood of the query signal being nulled at the backscatter tag as will be discussed below.

In another embodiment, the system, via the channel information, determines phase and attenuation for each antenna in the WiFi transmitter. In general, the individual query signal components received by the receiver (i.e., y) may be modelled as follows: y=Hx+n, where H is the wireless communication channel, x is the query signal (including the multiple signal components), and n is noise. After obtaining the channel information H, the transmitter can determine the transmitter, or query signal components, x using the equation y=Hx+n where y is zero for each of the antennas. X and y may also be seen as vectors based on the number of antennas within the transmitter and receiver devices.

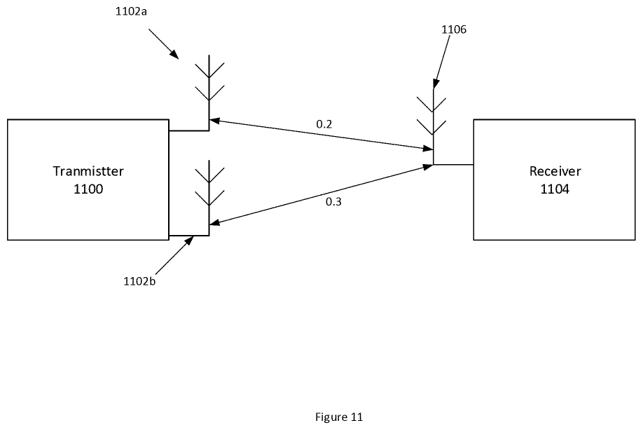

In one example calculation and configuration (such as schematically shown in FIG. 11), there are two antennas at the transmitter and one antenna at the receiver. It is understood that the configuration of FIG. 11 is being used for explanation purposes and not meant to be limiting with respect to how a WiFi backscatter system may be configured in accordance with the disclosure. In other embodiments, there may be more than two antennas at the transmitter and more than one antenna at the receiver.

In the current configuration, the WiFi transmitter 1100 includes a pair of antennas 1102 seen as a first antenna 1102a and a second antenna 1102b and the WiFi receiver 1104 includes a single antenna 1106. As seen in this example, a channel gain between the receiver antenna 1106 and the first antenna 1102a is 0.2 and a channel gain between the receiver antenna 1106 and the second antenna 1102b is 0.3.

In this example, the receiver transmits a signal (S) to the transmitter such as when the transmitter 1100 and the receiver 1104 are determining their communication channel. Based on the ratios or channel gains of the two transmitter antennas, the first antenna 1102a receives a signal 0.2S and the second antenna 1102b receives a signal 0.3S where 0.2S represents 0.2 of the power of the transmitted signal and 0.3S represents 0.3 of the power of the transmitted signal or the channel.

The transmitter then uses this channel information to generate, determine, or calculate, query signal components for each antenna that will be nulled at the receiver. In the current example, the transmitter transmits a query signal component signal S′ from the first antenna 1102a and a query signal component signal (−0.2/0.3)S′ from the second antenna 1102b so that the signal components from the first and second antennas null or cancel each other at the receiver.

It is understood that depending on the number of antennas, matrix mathematics may be used to generate the query signal components to account for the different vectors (directions).

If the WiFi transmitter has three (3) transmitting chains or more, multiple query signals (where nulling is achieved at the receiver) can be determined. This may be seen as the system including different pre-coding configurations that make y zero. In some embodiments, the method and system of the disclosure takes advantage of this property to recover from cases where the initially transmitted query signal is nulled at both the WiFi receiver and the backscatter tag such that there is no backscatter signal generated. This is due to the fact that if the query signal is nulled at the backscatter tag, the tag is not able to generate the backscatter tag signal as it requires an input signal. In the method of FIG. 2, the system may determine all of the query signals that may be transmitted that result in a nulling at the receiver or may determine a predetermined number of query signals and, if necessary, calculates or determines other query signals meeting the criteria if the predetermined number of query signals does not result in a backscatter signal being decoded or received.

The transmitter then transmits one of the query signals (204). By transmitting a query signal that is nulled at the receiver, a novel method and system for improving WiFi backscatter communication is provided.

In other embodiments, such as ones to address the situation where the query signal is nulled at the backscatter tag, the system may then determine if the WiFi receiver has received and decoded the backscatter signal or set of backscatter signals based on the query signal (206). The set of backscatter tag signals may also be seen as a single backscatter signal.

In one embodiment, the WiFi transmitter may communicate with the WiFi receiver to determine if a backscatter signal has been decoded. In another embodiment, the transmitter may communicate with an external node that monitors or communicates with WiFi receivers that are decoding backscatter signals to determine if the WiFi receiver that the transmitter is communicating with (as determined in (200)) has decoded a backscatter signal.

It is understood that in some embodiments, the transmitter may simply transmit one query signal that is nulled at the receiver without caring about whether or not the query signal is nulled at the backscatter tag whereby (206) does not need to be performed. In other embodiments, the receiver may not be able to decode a backscatter signal as it does not receive a backscatter signal such as when the query signal is nulled at the backscatter tag and therefore, the transmitter may be required to perform further actions to improve WiFi backscatter signal range. This is discussed in more detail below.

If the transmitter determines that the receiver did not receive or decode any backscatter signal (indicating that the query signal was nulled at the backscatter tag or that another problem may have occurred), the transmitter may then transmit another of the query signals (208) (as determined in (202)) and then performs another check to determine (206) if the next query signal has resulted in a backscatter signal being generated by the tag and decoded by the receiver. This may be repeated until the query signals in (202) are exhausted or the transmitter receives confirmation that the receiver has decoded a backscatter tag.

Since the WiFi receiver is only receiving the backscatter tag's signal as the query signal is nulled, the SINR will be much higher compared to past attempts by WiFi backscatter systems, resulting in a much longer signal range. To better understand the impact of this approach on eliminating or reducing self-interference and improving the SINR of the backscatter signal, a simulation was designed.

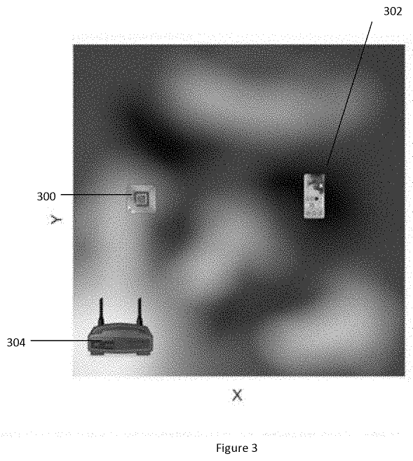

In the simulation, as schematically shown in FIG. 3a, the WiFi backscatter system included backscatter tag 300, a WiFi receiver 302 and a WiFi transmitter 304 with two antennas. The WiFi transmitter 304 transmits a query signal which is nulled at the WiFi receiver 302. For example the antennas transmit the same signal but with different pre-coding values or the antennas transmit the same amplitude signal but in opposite phases. For simplicity, it is assumed that the system operates in a free space scenario without multipath. A strength of the transmitter's query signal and the backscatter tag's reflection signal was calculated in different locations.

In FIG. 3, the darker areas reflect a lower SINR while the lighter areas represent a higher SINR. In most locations, the SINR is significantly below zero meaning that the query signal (interference) is much stronger than the backscatter tag's signal (shown as the darker areas). Therefore, it is tough or impossible for the receiver to detect the backscatter tag's signal in those locations. In the area around the backscatter tag 300, the SINR is close to zero which represents why current WiFi backscatter systems work only when the backscatter tag is very close to the receiver.

In this example, there are four areas that the SINR is significantly above zero, which may be seen as the directions in which the transmitter is nulling. There are four directions (instead of multiple spots) due to the free space scenario where the antennas are omni-directional and operate at one wavelength space. This shows that if the WiFi transmitter nulls its signal at the WiFi receiver location, the WiFi receiver can easily receive and decode the backscatter tag's signal even when the tag is far.

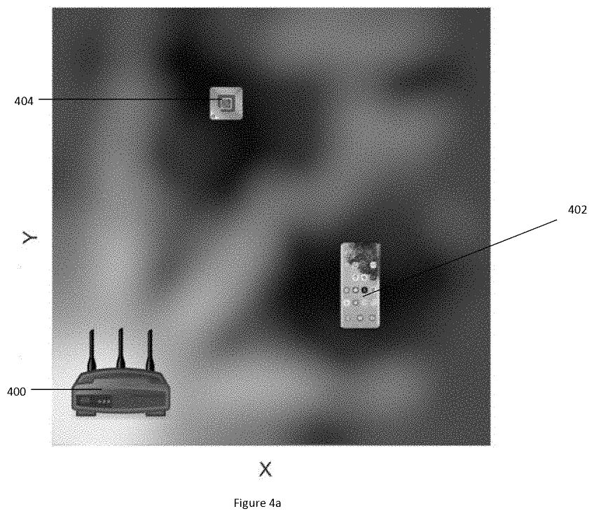

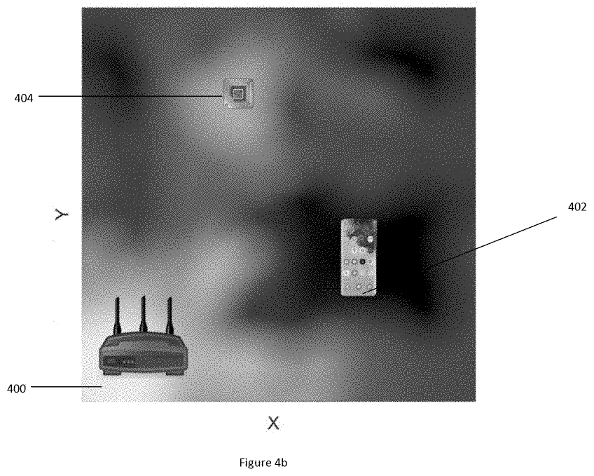

In another embodiment, as mentioned above, a scenario may arise where the nulling of the transmitter or query signal at the WiFi receiver also results in a nulling of the query signal at the backscatter tag. As such, the receiver will not have a signal to decode. Since the location of the backscatter tag is random with respect to the WiFi transmitter and the WiFi receiver, there is a chance that the backscatter tag is in a location that the query signal is also nulled. This is schematically shown in FIG. 4a

As shown in FIG. 4a, the transmitter 400 transmits a first query signal that results in a null signal at the WiFi receiver 402, however, the backscatter tag 404 is also in a null location and does not hear or reflect the transmitter's query signal. Although it is very unlikely this scenario happens, when it happens the backscatter tag is unable to communicate with the receiver using the first query signal. In order to overcome this problem whereby WiFi backscatter communication is possible regardless of the position of the tag with respect to the transmitter and/or the receiver, at least one other query signal can be transmitted. This is discussed above with respect to the method of FIG. 2. This may be seen as nulling using a different pre-coding values.

As discussed, the WiFi transmitter may pre-code its transmission such that the query signal received at a particular destination (i.e. the receiver location) is cancelled or nulled. Therefore, if the query signal is nulled at both the receiver and the backscatter tag, a different set of pre-coding values (or a different query signal) may be transmitted such that the new or different signal is nulled only at the receiver. This is schematically shown in FIG. 4b which shows SINR for a second query signal. If it is determined that the second query signal is also nulled at the backscatter tag, a third, and so on, query signal may be transmitted.

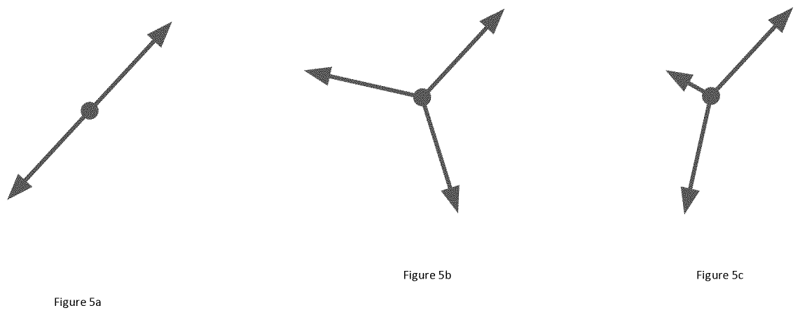

For WiFi transmitters that have only two antennas, the query signal components received at the receiver have the same amplitude but have 180 degree phase differences to cancel each other, as shown in FIG. 5a. Therefore, if the query signal includes two components (from two antennas) and the two signals cancel each other in both the receiver and tag locations, using a different pre-coding will not help remove the nulling at the backscatter tag as there are only two signals. Therefore, in some embodiments, it may be required that the WiFi transmitter include at least three (3) antennas to null the query signal. As shown in FIGS. 5b and 5c, which show schematic and non-exhaustive examples of phase and amplitude for signal components, when three antennas are used, there are multiple ways to generate signals that cancel or null each other at the receiver location. It is expected that at least one of these multiple solutions will result in a query signal that is not nulled at the backscatter tag location.

For example, in FIG. 5b, the three signals cancel out each other while having the same amplitude with 120 degree phase differences. In FIG. 5c, the three received signals cancel out each other while having different amplitudes and different phases. The ability to have different solutions to perform nulling enables the transmitter to perform nulling at the receiver location without nulling occurring at the backscatter tag's location due to the different query signals that may be transmitted. It is understood that it is very unlikely that the backscatter tag and the receiver are located in the exact same position whereby nulling at both locations is unavoidable.

As discussed above, FIG. 4b shows an example in which a different transmission configuration changes the location of where nulling occurs compared with the schematic example of FIG. 4a. In particular, by just changing the pre-coding values, the transmitter can still null at the receiver while making sure the backscatter tag is not in a location where the query signal is nulled. As discussed above with respect to FIG. 2, in one embodiment, the system may transmit different pre-coding values (or query signals) until the query signal is not nulled at the backscatter tag while it is nulled at the receiver or, in other words, until the WiFi receiver confirms that it has received and decoded the backscatter signal.

For the experiments, a USB WiFi card with a RTL8812AU chipset was used as a WiFi transmitter to transmit WiFi packets (or the query signal components). The card, or WiFi transmitter, was connected to a laptop. An ESP32 WiFi module was used as the WiFi receiver. Both the transmitter and receiver were off-the-shelf devices and no hardware modifications were made to them such that the disclosure may be performed using current technology. The WiFi transmitter was connected to two antennas transmitting the same signal but with different phases (seen as the two components of the query signals). This enables the WiFi transmitter to perform nulling at the WiFi receiver and since this was an experiment, the location of the backscatter tag was selected so that the query signal was not nulled at its location. For the backscatter tag, a WiFi antenna was connected to an HMC536 RF switch controlled by a microcontroller and set to continuously switch between reflective and non-reflective modes. The experiments were run in both line-of-sight and non-line-of-sight scenarios.

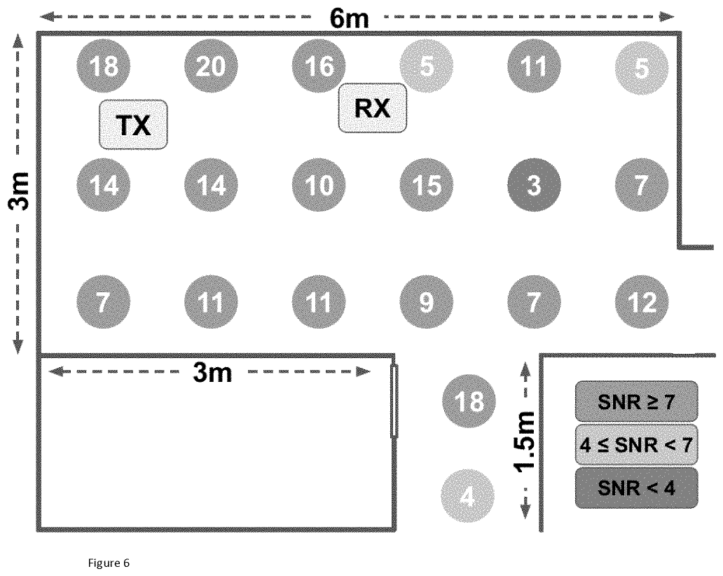

In one experiment, the backscatter signal strength was tested using a line-of-sight environment where the WiFi transmitter, the backscatter tag and the WiFi receiver could “see each other”. In this experiment, the WiFi transmitter and the WiFi receiver were placed in the same room, as shown in FIG. 6. A query signal (which would be nulled at the WiFi receiver) was determined and then transmitted by the WiFi transmitter in the form of WiFi packets. The backscatter tag was also placed in the same room at different locations during the experiment. The different locations of the backscatter tag as shown as circles in FIG. 6.

After the query signal was transmitted, for each location, the SNR of the backscatter tag's signal received at the receiver was measured using Channel State Information (CSI) as reported by the ESP32 module. In the experiment, the tag was placed at the 20 locations represented by the circles. For every location, the signal testing and receiving was executed for 60 seconds. The average SNR measured over the 60 second time frame for each location is listed within each of the circles.

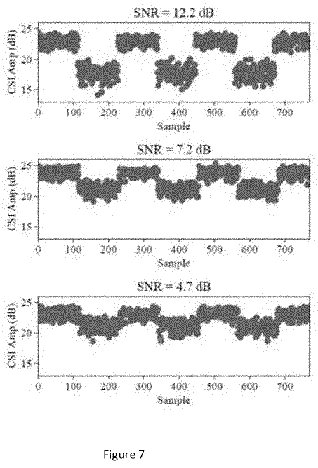

As can be seen in FIG. 6, the SNR of the backscatter tag's signal measured at the receiver was more than 7 dB for almost all locations. For a WiFi backscatter system using On-Off Keying (OOK) modulation, an SNR of 7 dB results in a Bit Error Rate (BER) of 10⁻³. The charts of FIG. 7 shows raw CSI measurements for SNRs of 4.7, 7.2, and 12.2 dB. This plot shows how the CSI amplitude changes at the receiver over time as the backscatter tag changes its state from reflective to non-reflective. At lower SNRs, such as 4.7 dB, the backscatter tag's effect is still visible, but it will cause a higher bit error rate for communication. When the SNR is more than 7 dB, the distinction between the two states becomes very clear. The results from the experiment showed that the method of the disclosure is a significant improvement over current WiFi backscatter communication systems. In order for most current WiFi backscatter systems to achieve this performance, the backscatter tag must be located between the two devices; be very close to one of the WiFi devices and/or the WiFi devices need to be modified. The disclosure does not require any hardware modifications to the transmitter or the receiver and can achieve such performance with the backscatter tag at almost every location within a room where the transmitter and receiver are located at father distances than currently possible.

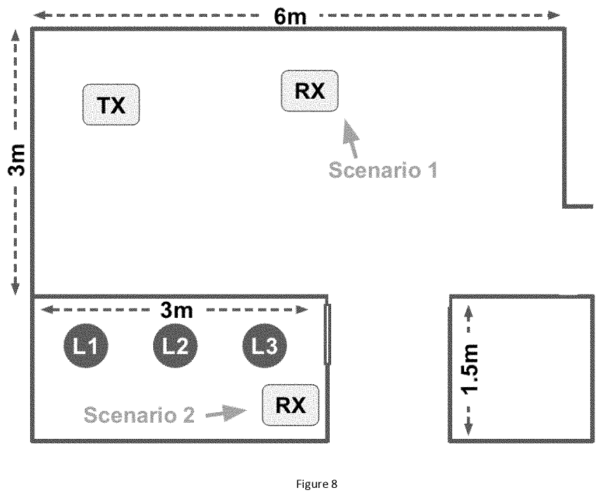

In a second experiment, a NLOS scenario was used where the WiFi transmitter and the WiFi receiver were in the same room but the backscatter tag was placed in another room, separated by a wall. The setup is schematically shown as Scenario 1 in FIG. 8. Current WiFi backscatter systems do not operate in this scenario since the signal of the backscatter tag is significantly attenuated by the wall. Similar to the experiment discussed above, the backscatter tag was set to switch between reflective and non-reflective modes. During the experiment, the backscatter tag's signal power was measured at the receiver using CSI changes as reported by the Wifi receiver. In a second NLOS experiment, the transmitter was placed in one room and the receiver and backscatter tag were placed in separate room (Scenario 2 in FIG. 8).

FIG. 8(b) shows the result of these experiments. The experimental results showed that in a NLOS scenario where there is a wall between the backscatter tag and the WiFi transmitter and receiver devices (Scenario 1), suitable SNR for extending the signal range of a WiFi backscatter system can be achieved whereby the receiver can still decode the backscatter signal that is generated as a result of the query signal transmitted by the transmitter. For Scenario 2, an SNR of more than 10 dB can be achieved at the receiver which enables the receiver to decode the backscatter tag signal.

In another experiment, the signal range achievable by the disclosure was compared to the signal range achievable by current WiFi backscatter systems. In this experiment, the range of a first in-channel WiFi backscatter system using the method of the disclosure and not using the method of the disclosure were used. The results were then compared with the signal range of state-of-the-art WiFi backscatter systems, such as SyncScatter and WiTAG as these two backscatter systems have reported the best signal range for out-of-channel and in-channel backscatter systems, respectively.

The comparisons were performed using three different scenarios: (1) where there is no LOS between the backscatter tag and any WiFi device; (2) where there is no LOS between the WiFi devices, but the tag has LOS with one of the WiFi devices; and (3) there is LOS between the tag and the WiFi devices.

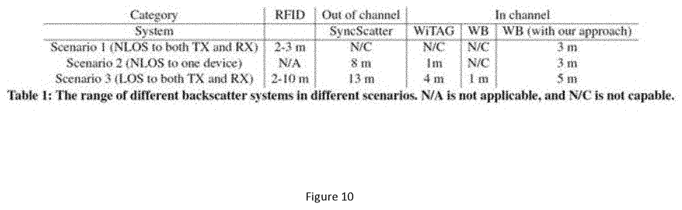

The first scenario is the most challenging since the tag's backscatter signal as well as its reflection must pass through a wall. The table of FIG. 10 shows the results of this comparison.

It can be seen that the disclosure significantly improves the range of the first WiFi backscatter system (denoted as WB). In particular, using the disclosure, a signal range of 5 m and 3 m in LOS and NLOS scenarios, respectively, were achieved while the first WiFi backscatter system range was 1 m in LOS and not able to communicate in NLOS scenarios. It is expected that a similar gain can be achieved if the nulling method of the disclosure is used with state-of-the-art WiFi backscatter systems.

It was also observed that out-of-channel WiFi backscatter systems achieve better signal range than in-channel backscatter systems. This is expected since they solve the interference problem by moving the tag backscatter signal to another channel. It was also observed that none of existing tested WiFi backscatter systems work in a scenario where the tag has no LOS to any WiFi device. However, WiFi backscatter systems using the method of the disclosure was able to achieve communication over a 3 m signal range between the backscatter tag and the WiFi receiver.

As a comparison with other current systems, for RFID systems, the signal range is 2 to 10 m in LOS and 2 to 3 m in NLOS scenarios, however, RFID systems use directional antennas which improves their range but at the cost of limited field of view. This is not a problem with the system and method of the disclosure. One advantage of the disclosure is that a WiFi backscatter system and/or method of the disclosure may be used in IoT applications where the signal range is improved compared with current systems in LOS and NLOS scenarios.

In the preceding description, for purposes of explanation, numerous details are set forth in order to provide a thorough understanding of the embodiments. However, it will be apparent to one skilled in the art that these specific details may not be required. It will also be understood that aspects of each embodiment may be used with other embodiments even if not specifically described therein. Further, some embodiments may include aspects that are not required for their operation but may be preferred in certain applications. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with other modules and elements, including circuitry or the like, to perform the described tasks.

The above-described embodiments are intended to be examples only. Alterations, modifications and variations can be effected to the particular embodiments by those of skill in the art without departing from the scope, which is defined solely by the claim appended hereto.

What is claimed is:

1. A method of extending signal range for a WiFi backscatter system comprising:
determining a channel for communication with a WiFi receiver;
calculating at least one query signal based on the channel for communication; and
transmitting one of the at least one query signals;
wherein the at least one query signal is nulled when received by the WiFi receiver;
wherein transmitting the at least one query signal is performed by a WiFi transmitter.

2. The method of claim 1 wherein calculating the at least one query signal comprises:
determining a number of transmitting chains; and
calculating a query signal for each of the transmitting chains.

3. The method of claim 2 further comprising:
storing each query signal for each of the transmitting chains.

4. The method of claim 2 wherein calculating a query signal for each of the transmitting chains comprises:
selecting one of the transmitting chains;
determining a number of antennas associated with the selected transmitting chain; and
determining an individual signal for transmission by each of the number of antennas;
wherein the individual signals for transmission are nulled at the WiFi receiver; and
wherein a combination of the individual signals for transmission by each of the number of antennas represent the at least one query signal.

5. The method of claim 1 further comprising:
determining if the WiFi receiver has decoded a backscatter tag signal; and
transmitting another of the at least one query signals if the WiFi receiver has not decoded the backscatter tag signal;
wherein the determining if the WiFi receiver has decoded the backscatter tag signal and transmitting another of the at least one query signals if the WiFi has not decoded the backscatter tag signal are repeated until the WiFi receiver has decoded the backscatter tag signal or each of the at least one query signals has been transmitted.

6. The method of claim 5 wherein determining if the WiFi receiver has decoded a backscatter tag signal comprises:
communicating with the WiFi receiver to determine if the WiFi receiver has decoded the backscatter tag signal.

7. The method of claim 5 wherein determining if the WiFi receiver has decoded a backscatter tag signal comprises:
communicating with an external node monitoring WiFi receiver activity.

8. The method of claim 1 wherein determining a channel for communication with a WiFi receiver comprises channel sounding.

9. The method of claim 1 wherein determining a channel for communication with a WiFi receiver comprises determining a relationship between antennas associated with the WiFi transmitter and at least one antenna associated with the WiFi receiver.

10. A non-transitory computer-readable medium storing a WiFi backscatter communication program including instructions that, when executed by a processor, causes a WiFi transmitter to:
determine a channel for communication with a WiFi receiver;
calculate at least one query signal based on the channel for communication; and
transmit one of the at least one query signals;
wherein the at least one query signal is nulled when received by the WiFi receiver;
wherein transmitting the at least one query signal is performed by a WiFi transmitter.

11. The non-transitory computer-readable medium of claim 10 wherein the instructions, when executed by the processor, cause the WiFi transmitter to calculate the at least one query signal, the WiFi transmitter:
determines a number of transmitting chains; and
calculates a query signal for each of the transmitting chains.

12. The non-transitory computer-readable medium of claim 11 wherein the instructions, when executed by the processor, cause the WiFi transmitter to calculate a query signal for each of the transmitting chains, the WiFi transmitter:
selects one of the transmitting chains;
determines a number of antennas associated with the selected transmitting chain; and
determines an individual signal for transmission by each of the number of antennas;
wherein the individual signals for transmission are nulled at the WiFi receiver; and
wherein a combination of the individual signals for transmission by each of the number of antennas represent the at least one query signal.

13. The non-transitory computer-readable medium of claim 10 wherein the instructions, when executed by the processor, further cause the WiFi transmitter to:
determine if the WiFi receiver has decoded a backscatter tag signal; and
transmit another of the at least one query signals if the WiFi receiver has not decoded the backscatter tag signal;
wherein the determining if the WiFi receiver has decoded the backscatter tag signal and transmitting another of the at least one query signals if the WiFi has not decoded the backscatter tag signal are repeated until the WiFi receiver has decoded the backscatter tag signal or each of the at least one query signals has been transmitted.

14. The non-transitory computer-readable medium of claim 13 wherein the instructions, when executed by the processor, cause the WiFi transmitter to determine if the WiFi receiver has decoded a backscatter tag signal, the WiFi transmitter:
communicates with the WiFi receiver to determine if the WiFi receiver has decoded the backscatter tag signal.

15. The non-transitory computer-readable medium of claim 13 wherein the instructions, when executed by the processor, cause the WiFi transmitter to determine if the WiFi receiver has decoded a backscatter tag signal, the WiFi transmitter:
communicates with an external node monitoring WiFi receiver activity.

16. A WiFi transmitter comprising:
a processor for executing non-transitory computer-readable medium storing a WiFi backscatter communication program including instructions that, when executed by the processor, cause the WiFi transmitter to:
determine a channel for communication with a WiFi receiver;
calculate at least one query signal based on the channel for communication; and
transmit one of the at least one query signals;
wherein the at least one query signal is nulled when received by the WiFi receiver.

17. The WiFi transmitter of claim 16 further comprising a database for storing each of the at least one query signals.

18. The WiFi transmitter of claim 16 further comprising a set of antennas for transmitting the one of the at least one query signals.
